(19) United States
(12) Patent Application Publication
(10) Pub. No.: US 2007/0189562 A1
(43) Pub. Date: Aug. 16, 2007

(54) CONTACT-LESS ELECTRIC SWITCH

(76) Inventor: Chung Jen Chiu, Taipei (TW)

Correspondence Address: SINORICA, LLC, 528 FALLSGROVE DRIVE, ROCKVILLE, MD, 20850, US

(21) Appl. No.: 11/689,693

(22) Filed: Mar. 22, 2007

Related U.S. Application Data
(63) Continuation-in-part of application No. 11/325,542, filed on Jan. 5, 2006, now abandoned.

(51) Int. Cl. H04R 25/00

(52) U.S. Cl. 381/315

(57) ABSTRACT

A contact-less electric switch applied to an electric device includes a detector and controlling circuits. The detector including a microphone is used for detecting waves through the microphone and generating an electrical signal accordingly. The controlling circuits are connected with the electric device and the detector for receiving the electrical signal and controlling the electric device to be turned on or turned off.

The present invention is a continuation-in-part of U.S. application Ser. No. 11/325,542, filed on Jan. 05, 2006, and is herein incorporated in its entirety by reference for all purposes.

### BACKGROUND OF THE INVENTION

1. Field of the Invention

The present invention relates to a contact-less electric switch, and particularly relates to a contact-less electric switch for switching an electric device between different states through detecting waves.

2. Description of Related Art

Conventionally, switches of electric devices, such as lamps, are mechanical components. The conventional mechanical switches are mainly divided into two types. One is switched by pressing, such as a membrane switch, with direct contacting to the switch. A conductive component is pressed up or down to close or open circuit, so that the electric device is turned on or turned off accordingly. The other is a guillotine switch, which is controlled by changing the angle of a switching component. It is commonly used and installed on the walls to switch an illuminatning device.

All of the conventional mechanical switches are contact switches, such that there must be sufficient space for an user to controll the swithces. Furthermore, the conventional mechanical switches are continuously touched by users and the switches may be smudged due to repeated contacts. Therefore, not only the mechanical-wearout is a problem but also the hygiene issues of direct contact to the switch by different users is a big concern.

### SUMMARY OF THE INVENTION

The present invention is to provide a contact-less electric switch, which is controlled by detecting waves, so as to overcome the problems mentioned above.

The present invention is to provide a contact-less electric switch applied to an electric device. The contact-less electric switch includes a detector and controlling circuits. The detector including a microphone is used for detecting waves through the microphone and generating an electrical signal accordingly. The controlling circuits are connected with the electric device and the detector, for receiving the electrical signal and controlling the electric device to be turned on or turned off.

### BRIEF DESCRIPTION OF THE DRAWINGS

FIG. 1 is a block diagram illustrating a contact-less electric switch of the present invention;

FIG. 2A is a schematic drawing showing the contact-less electric switch applied to an electric candle in the turned-on state according to a first embodiment of the present invention;

FIG. 2B is a schematic drawing showing the contact-less electric switch applied to an electric candle in the turned-off state according to the first embodiment of the present invention;

FIG. 3A is a schematic drawing showing the contact-less electric switch applied to a lamp in the turned-on state according to a second embodiment of the present invention;

FIG. 3B is a schematic drawing showing the contact-less electric switch applied to the lamp in FIG. 3A in the turned-off state;

FIG. 4A is a schematic drawing showing the contact-less electric switch applied to a snowman decoration according to a third embodiment of the present invention;

FIG. 4B is a block diagram illustrating the contact-less electric switch according to the third embodiment of the present invention; and

FIG. 5 is a schematic drawing showing the contact-less electric switch applied to a Halloween decoration according to a fourth embodiment of the present invention.

### DETAILED DESCRIPTION OF THE PREFERRED EMBODIMENT

Terminology and Lexicography:

Microphone: A device captures air waves or sound waves or water waves and transforms the captured waves into electrical signals.
   The following provides exemplary embodiments of the present invention with reference to the accompanying drawings.

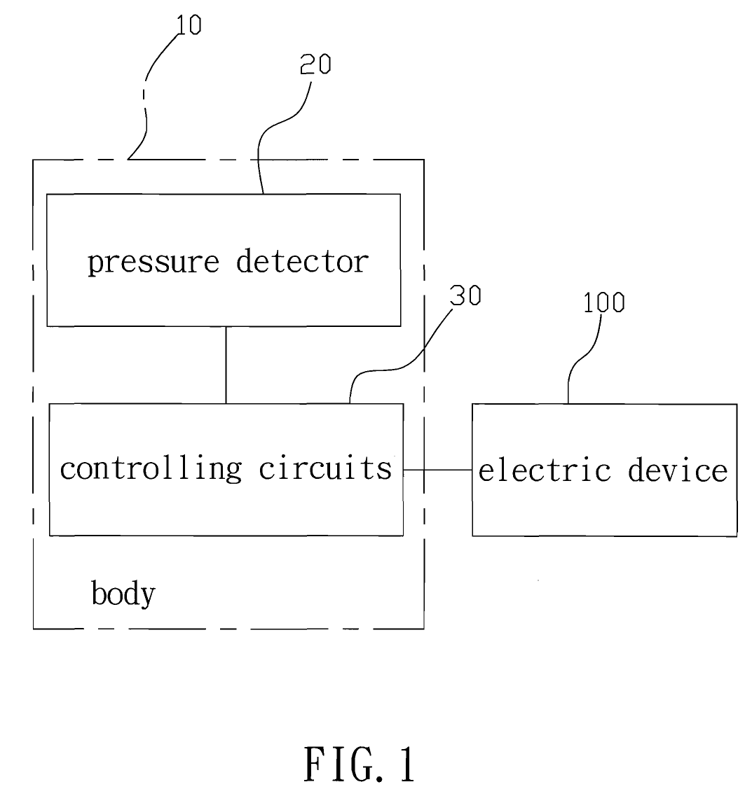

In FIG. 1, according to the present invention, a contact-less electric switch applied to an electric device 100 is provided. For example, the electric device 100 can be a home appliance, such as a fan, an illuminating device or a motor. The contact-less electric switch comprises a body 10, a detector 20, and controlling circuits 30. The detector 20 includes a microphone and is used for detecting waves through the microphone and generating an electrical signal accordingly. The microphone can be disposed inside the body 10 and connected with the surroundings through a hole. Or, the microphone can be disposed on the body 10 and exposed to the surroundings directly. The controlling circuits 30 are installed inside the body 10 and connect the electric device 100 with the detector 20. The controlling circuits 30 are used for receiving the electrical signal from the detector 20 and transforming the electrical signal into a voltage signal. As a result, the electric device 100 is turned on, turned off or switched to another state by the controlling circuits 30.

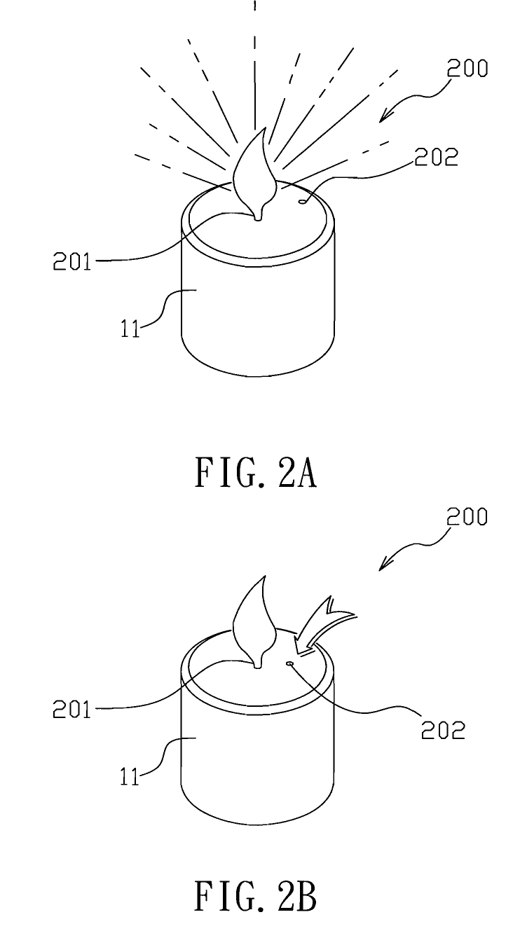

In FIGS. 2A and 2B, according to a first embodiment of the present invention, the contact-less electric switch is applied to an electric candle 200. A light emitting diode 201 is set on the top of a candle body 11 of the electric candle 200 and is shaped as a flame. A hole 202 is formed around the light emitting diode 201. A detector includes a microphone disposed inside the candle body 11 and under the hole 202. The microphone is connected with the surroundings through the hole 202. The detector and the controlling circuits are connected together, and the light emitting diode 201 and the controlling circuits are connected together as well (not shown in FIGS. 2A and 2B). The relative locations of the detector and the controlling circuits are the same as those shown in FIG. 1 and are well known by anyone who is skilled in the field.

When the contact-less electric switch is turned on, the detector detects waves transmitted into the hole 202 through the microphone and then generates a first electrical signal accordingly. For example, the user blows air into the hole 202, so air waves are transmitted to the microphone under the hole 202. Or, the user makes a sound near the hole 202, so sound waves are transmitted to the microphone under the hole 202. When receiving the waves, the microphone acts as a transducer that converts waves into a first electrical signal. The first electrical signal is sent to the controlling circuits by the detector and transformed into a voltage signal by the controlling circuits. Then, the light emitting diode 201 is turned on according to the voltage signal, consequently the electric candle 200 is lighted (FIG. 2A). When waves are again transmitted into the hole 202, the detector detects the waves through the microphone and generates a second electrical signal accordingly. The second electrical signal is sent to the controlling circuits and then transformed into a voltage signal by the controlling circuits. The light emitting diode 201 is turned off according to the voltage signal, so the electric candle 200 is snuffed out (FIG. 2B).

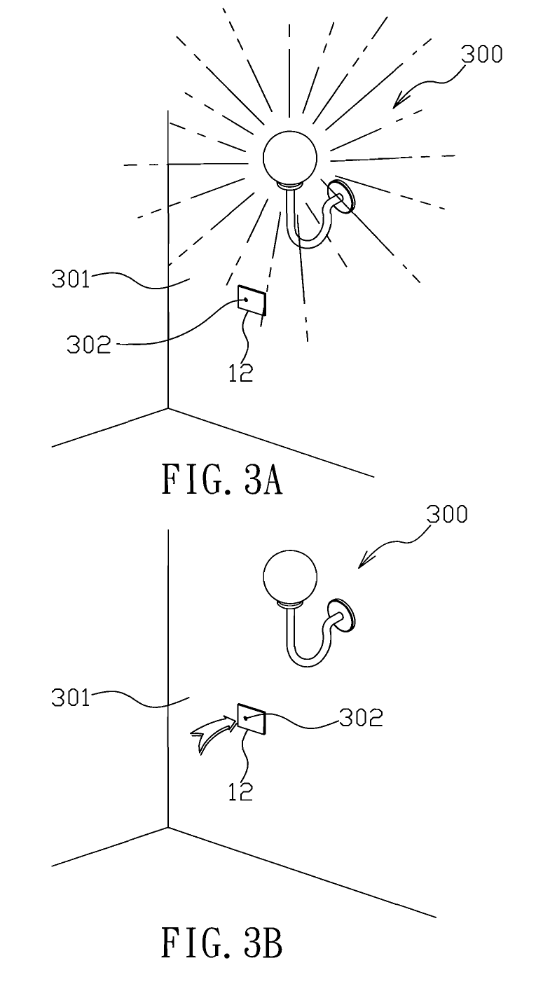

In FIGS. 3A and 3B, according to a second embodiment of the present invention, the contact-less electric switch is applied to a lamp 300. A body 12 is installed on the wall 301. A hole 302 is formed through the wall 301. A detector 22 includes a microphone disposed under the hole 302 and inside the body 12. The microphone is connected with the surroundings through the hole 302. The detector 22 and the controlling circuits are connected together, and the lamp 300 and the controlling circuits are connected together as well (not shown in FIGS. 3A and 3B). The relative locations of the detector and the controlling circuits are the same as those shown in FIG. 1 and are well known by anyone who is skilled in the field.

When the contact-less electric switch is turned on, the detector 22 detects waves transmitted into the hole 302 through the microphone and generates an electrical signal accordingly. Similar to the first embodiment, the lamp 300 is lighted (FIG. 3A). If waves are again transmitted into the hole 302, the lamp 300 is turned off (FIG. 3B).

According to these embodiments of the present invention, the diameter of the hole is preferably less than 3 mm, so as to gather the air waves up without influence of other air flow. Specifically, a threshold value can be set according to the embodiment of the present invention. When the current flow generated by the detector according to the waves is higher than the threshold value, the electrical signal would be generated.

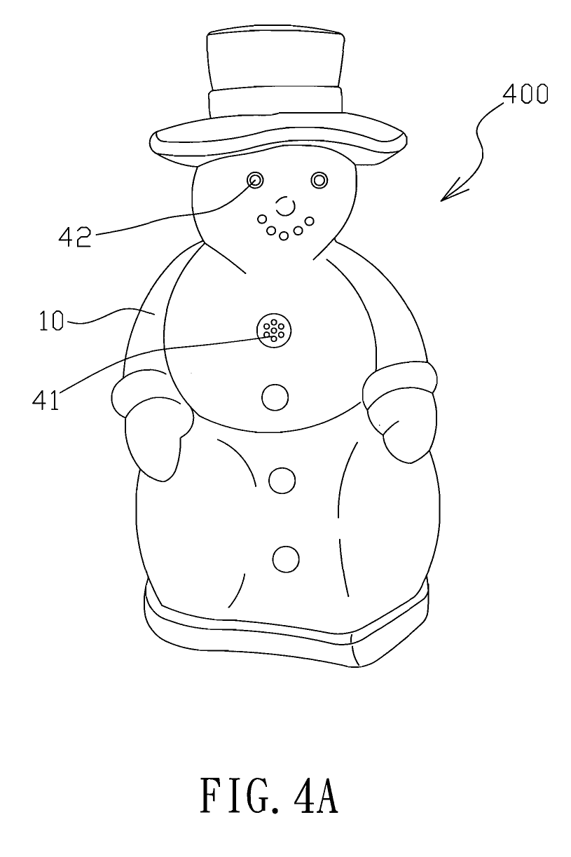

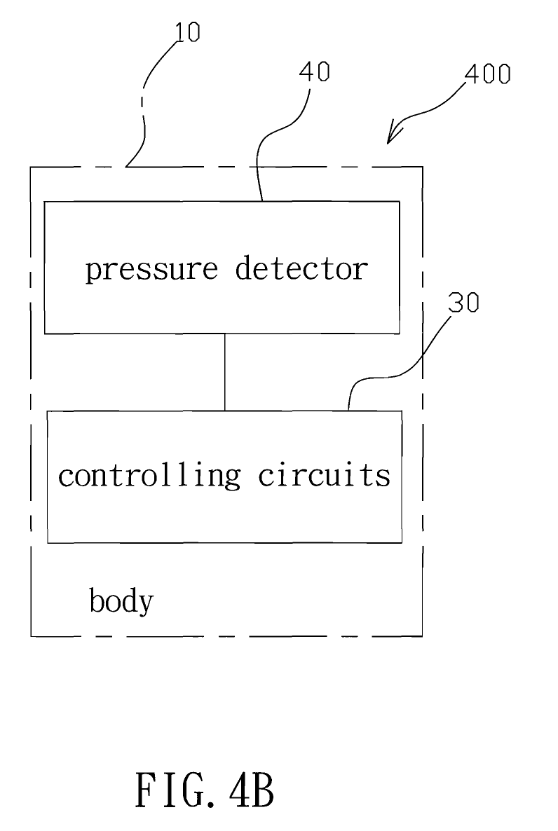

Please referring to FIGS. 4A and 4B, the contact-less electric switch is applied to a snowman decoration 400 according to a third embodiment of the present invention. The contact-less electric switch includes a body 10, a detector 40 and controlling circuits 30. The body 10 is shaped like a snowman. The detector 40 includes a microphone 41. The microphone 41 can be disposed on the body 10 and exposed to the surroundings. Or, the microphone 41 can be disposed inside the body 10 and connected to the surroundings through a hole (the same as the hole 202 in FIG. 2A). The microphone 41 detects sound waves or air waves, such as voice (generated by speaking, clapping, etc) or blown air. The microphone 41 generates an electrical signal according to the sound waves or air waves. The controlling circuits 30 are controlled by the electrical signal, so that the snowman decoration 400 is turned on, turned off or switched to another state accordingly. A light emitting diode 42 is disposed on the body 10. For example, the light emitting diode 42 is disposed in the eye region or inside the body 10. The controlling circuits 30 control the light emitting diode 42 to open or close circuit, so the light emitting diode 42 is turned off, turned on or switched to another state accordingly. The same as the above embodiments, the controlling circuits 30 are disposed inside the body 10 and connected to the detector 40. The controlling circuits 30 can also control other illuminating or audio devices connected to the controlling circuits 30.

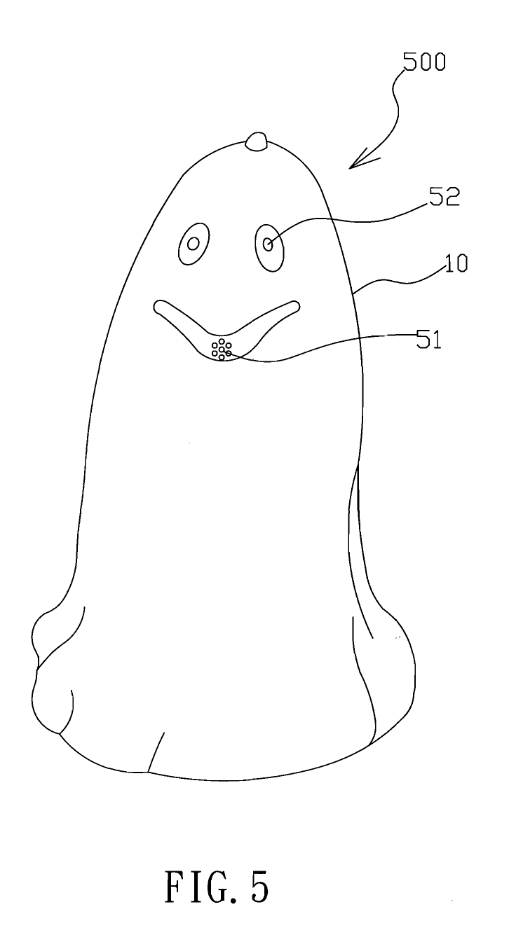

Please referring to FIG. 5, the contact-less electric switch is applied to a Halloween decoration 500 according to a fourth embodiment of the present invention. The main components and operation of the Halloween decoration 500 are the same as those of the snowman decoration 400 in the third embodiment. As shown in FIG. 5, a microphone 51 is disposed in the mouth region of a body 10. A light emitting diode 52 is disposed in the eye region of the body 10 or inside the body 10. Similarly, the microphone 51 detects sound waves or air waves of the surroundings, such as voice (generated by speaking, clapping, etc) or blown air, and then generates an electrical signal accordingly. Controlling circuits 30 are controlled by the electrical signal, so that the Halloween decoration 500 is turned on, turned off, or switched to another state accordingly. In other words, the light emitting diode 52 is on, off or switched to another state through the contact-less electric switch. According to the present invention, the contact-less electric switch is controlled by detecting waves to switch the electric device to be turned on, be turned off or another state. It is easy for an user to switch the electric device by blowing air or making a sound. The contact-less electric switch of the present invention includes following advantages. The volume of the contact-less electric switch is small, so the space for disposing the contact-less electric switch is reduced. The electric current of the contact-less electric device is small, so the electricity consumption is saved. For example, the static current is about 250 μA/4.5 V. The life of the contact-less electric switch is prolonged. Also, the contact-less electric switch prevents the user from getting an electric shock because the user does not have to touch the contact-less electric switch. Furthermore, when the contact-less electric switch is installed in a public place, the user is not infected with virus through touching the electric device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A contact-less electric switch wherein
the switch turns ON an electric device in response of detecting waves wherein the waves are selected from the group consisting of air waves, sound waves, and water waves.

2. The contact-less electric switch of claim 1 comprises,
a detector comprising a microphone wherein the microphone detecting the waves;
controlling circuits receiving electrical signals generated by the detector in response of the detection of the waves; and
the controlling circuits generate voltage signals in response of receiving the electrical signals.

3. The contact-less electric switch of claim 2 wherein
the voltage signals control flowing or terminating electric current flow.

4. The contact-less electric switch of claim 3 wherein
the controlling circuits connect to the electric device wherein the electric device is turned ON in response of receiving the electric current flow.

5. The contact-less electric switch of claim 2 wherein
the detector determines wave pressure in response of the detection of waves;
the detector generates the electrical signals when the wave pressure exceeds a pre-determined threshold.

6. The contact-less electric switch of claim 5 wherein
the voltage signals control flowing or terminating electric current flow.

7. The contact-less electric switch of claim 2 further comprises
a body, wherein the microphone is disposed inside the body.

8. The contact-less electric switch of claim 7 further comprises
a hole is formed on the body and adjacent to the microphone; and the microphone is connected with surroundings through the hole.

9. The contact-less electric switch according to claim 8, wherein
the diameter of the hole is less than 3 mm.

10. A contact-less electric switch wherein
the switch turns OFF an electric device in response of detecting waves wherein the waves are selected from the group consisting of air waves, sound waves, and water waves.

11. The contact-less electric switch of claim 10 comprises,
a detector comprising a microphone wherein the microphone detecting the waves;
controlling circuits receiving electrical signals generated by the detector in response of the detection of the waves; and
the controlling circuits generate voltage signals in response of receiving the electrical signals.

12. The contact-less electric switch of claim 11 wherein
the voltage signals control flowing or terminating electric current flow.

13. The contact-less electric switch of claim 12 wherein
the controlling circuits connect to the electric device wherein the electric device is turned OFF in response of receiving the electric current flow.

14. The contact-less electric switch of claim 11 wherein
the detector determines wave pressure in response of the detection of waves;
the detector generates the electrical signals when the wave pressure exceeds a pre-determined threshold.

15. The contact-less electric switch of claim 14 wherein
the voltage signals control flowing or terminating electric current flow.

16. The contact-less electric switch of claim 11 further comprises
a body, wherein the microphone is disposed inside the body.

17. The contact-less electric switch of claim 16 further comprises
a hole is formed on the body and adjacent to the microphone; and the microphone is connected with surroundings through the hole.

18. The contact-less electric switch according to claim 17, wherein the diameter of the hole is less than 3 mm.
